(19) United States
(12) Patent Application Publication
(10) Pub. No.: US 2010/0011770 A1
(43) Pub. Date: Jan. 21, 2010

(54) Gas Turbine Premixer with Cratered Fuel Injection Sites

(76) Inventors: Ronald James Chila, Greer, SC (US); Ronald Scott Bunker, Niskayuna, NY (US); John Charles Intile, Simpsonville, SC (US)

Correspondence Address: NIXON & VANDERHYE P.C., 901 NORTH GLEBE ROAD, 11TH FLOOR, ARLINGTON, VA, 22203, US

(21) Appl. No.: 12/176,510

(22) Filed: Jul. 21, 2008

(51) Int. Cl. F02C 1/00

(52) U.S. Cl. 60/737

(57) ABSTRACT

A premixer for a gas turbine combustor includes a swirler including a plurality of turning vanes that impart swirl velocity to airflow through the premixer, and at least one fuel injection site enabling fuel to mix with the airflow in the premixer. The fuel injection site terminates in a cratered hole. The cratered hole increases mixing efficiency and increases flashback/flameholding resistance.

### BACKGROUND OF THE INVENTION

The invention relates generally to mixing efficiency and increased flashback/flameholding resistance in a gas turbine and, more particularly, to a premixer for a gas turbine combustor including cratered fuel injection sites.

In existing premixers for gas turbine combustors, fuel jets emanate from a fuel peg or swirler vane and are reminiscent of a jet in a cross flow. The fuel jets typically have relatively large wake regions associated with them. The fuel jet is mixed via the turbulent swirling flow within the premixer passages and via the evolution of the fuel jet into coherent vortical structures. The bulk of this mixing takes place downstream of the injection site.

Premixer efficiency is an important design issue in that NOx emissions are directly tied to levels of mixedness.

### BRIEF DESCRIPTION OF THE INVENTION

In an exemplary embodiment, a premixer for a gas turbine combustor includes a swirler including a plurality of straight or turning vanes that affect velocity characteristics of airflow through the premixer, and at least one fuel injection site enabling fuel to mix with the airflow in the premixer. The fuel injection site terminates in a cratered hole.

In another exemplary embodiment, a method for improving flashback and flameholding resistance in a gas turbine combustor includes a step of forming at least one cratered hole at an airflow end of a fuel injection site in a premixer.

In yet another exemplary embodiment, a premixer for a gas turbine combustor includes a swirler including a plurality of straight or turning vanes that affect velocity characteristics of airflow through the premixer, a plurality of fuel injection sites enabling fuel to mix with the airflow in the premixer, and a cratered hole formed at the end of at least one of the fuel injection sites on a surface of at least one of the turning vanes.

### BRIEF DESCRIPTION OF THE DRAWINGS

FIG. 1 is a perspective view of a premixer for a gas turbine combustor;

FIG. 2 is a cross sectional view of a fuel injection site terminating in a cratered hole; and

FIG. 3 illustrates mixing characteristics using cratered holes as compared with conventional straight holes.

### DETAILED DESCRIPTION OF THE INVENTION

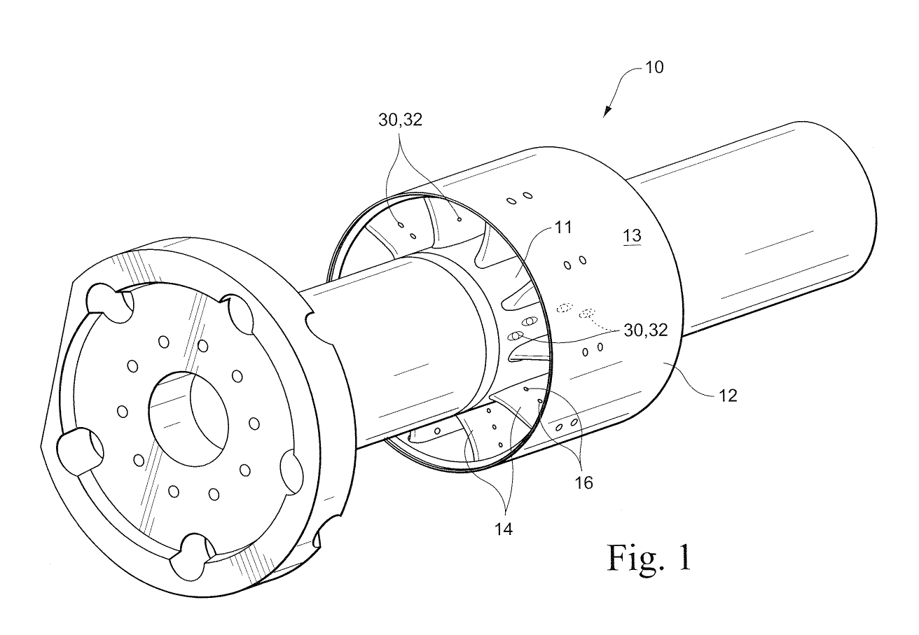

FIG. 1 is a perspective view of a gas turbine premixer 10. Typical premixers 10 are provided with a swirler 12, starting at the hub 11 and terminating at the shroud 13 including a set of straight or turning vanes 14 that may add swirl velocity to the airflow through the premixer 10. The swirling motion enhances mixing and provides for flame stabilization downstream within the combustor. Fuel injection sites 16 are also typically formed in the turning vanes 14, with fuel delivery passages traditionally located radially interior to the premixer hub also including cavities with the turning vanes.

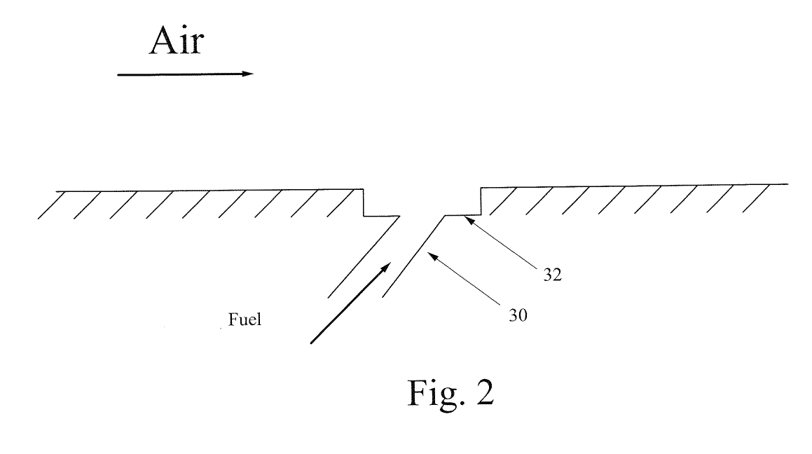

It has been discovered that a cratered hole at a terminating end of the fuel injection sites serves to increase local and bulk mixing effects. FIG. 2 is a cross sectional view of a fuel injection site including a cylindrical fuel hole 30 terminating in a cratered hole 32 formed in a surface adjacent the airflow through the premixer 10. The cratered hole can be incorporated into the combustor premixer via any multiple of acceptable manufacturing processes, including, for example, any form of standard or laser drilling, electrical discharge machining (EDM), casting or the like.

In accordance with the present description, the term “cratered hole” refers to any opening or hole that is larger than the fuel hole 30 through which fuel is injected into the airflow. The cratered holes 32 can be formed in any combination of shapes and orientation, and the size and depth of the craters may also be varied. The term additionally is intended to include a two-dimensional crater or trench design that may be used in place of or in combination with discrete craters. The depth of the crater or trench 32 is preferably in the range of 0.5 D to 1.5 D, where D is the hole 30 diameter (i.e., internal throat diameter, not surface footprint diameter). The crater effective average diameter is preferably in the range of 1.5 D to 3 D. Effective average diameter is the equivalent circular diameter for the actual area, regardless of the shape of the area. In a trench construction, the trench width is preferably in the range of 1 D to 3 D. With the trench construction, a width of 1 D is possible if the axis of the hole 30 is oriented along the lengthwise direction of the trench.

Placement of the crater or trench 32 relative to the hole 30 should preferably be such that the distance between the downstream edge of the hole and the crater edge is in the range of 0 to 1 D. In this context, “downstream” is defined as the direction of fuel jet injection. In the trench construction, if the hole 30 is oriented along the trench length, then this range is inconsequential, or goes to infinity. The configuration is beneficial, however, especially for ease of manufacturing. The range of 0 to 1 D preferably applies when the hole 30 axis is oriented transverse to the lengthwise direction of the trench.

As noted, the shape of the crater 32 can vary from circular to a linear trench, and all variations between, and preferably the distance between adjacent holes 30 is no more than 3 D. If hole adjacent spacing is more than 3 D, then the crater shape may vary from circular to elliptic, square, oblong, etc. within the restriction of effective average diameter range. Trench shape can vary from a linear to sawtooth or periodic edge placement, again preferably with a width range that still follows the recommended values.

Fuel is injected through the cylindrical fuel holes 30 through any multiple of the cratered holes 32, where the number and combination of cratered hole shapes and orientation are varied in order to obtain an increased mixing rate without compromising flameholding margin or pressure drop. The fuel injection direction relative to the airflow may also be varied. By using cratered holes for premixing, lateral spreading (mixing) of the fuel is greatly enhanced. Shorter mixing distances enable shorter combustion lengths and hence reduce residence time. As a consequence, the cratered holes serve as a means for reducing NOx emissions. The cratered holes also allow for the fuel to lay down adjacent the premixer surface, which provides for a rich mixture adjacent the premixer surface. The rich mixture provides for increased flashback/flameholding resistance.

The cratered fuel holes 32 may be formed on the surface of the turning vanes 14 or on any fuel injection site within the premixer including the adjoining hub 11 or shroud 13 of the vane (see FIG. 1). With the cratered fuel holes, the fuel jet is allowed to expand into a surface concavity prior to mainstream injection. This expansion coupled with the interaction of the fuel stream with the lip of the surface concavity lead to enhanced mixing, resulting in lower NOx emissions, which is one of the primary design goals of modern gas turbine combustors.

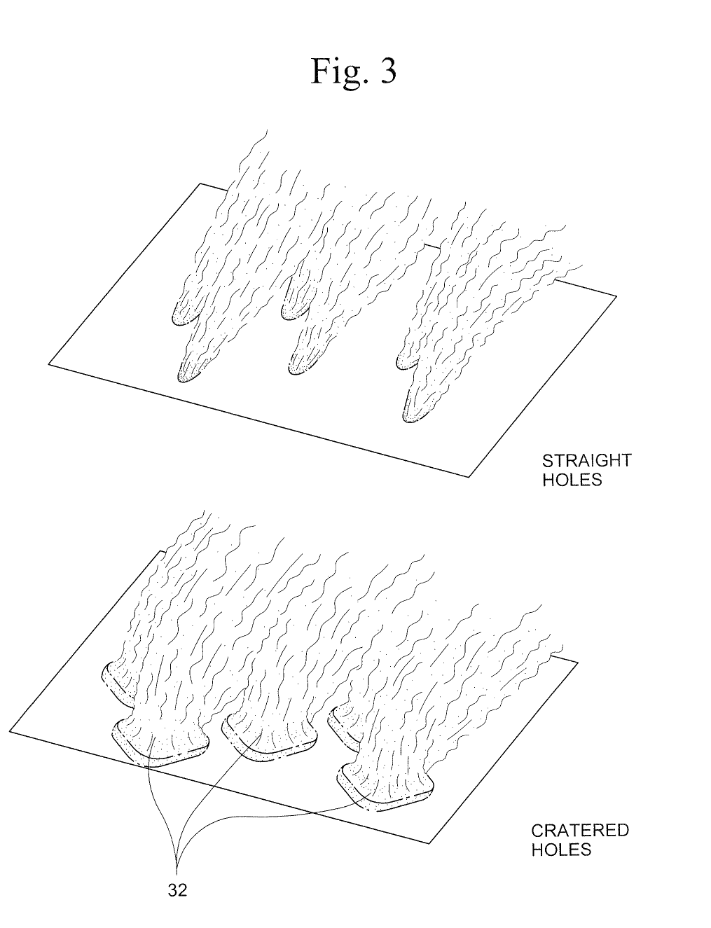

FIG. 3 shows a comparison between fuel injection sites through straight holes into the airflow versus fuel injection sites including cratered holes. As seen in FIG. 3, the cratered holes reduce jet penetration and wake effects, which result in increased resistance to flashback/flameholding. The cratered fuel holes can also help to reduce overall fuel supply pressure or pressure ratio, thereby aiding in the mitigation of combustion dynamics. It is clear from FIG. 3 that the cratered holes provide for increased lateral spreading of the fuel in the premixer, which results in shorter mixing distances and residence times. On enhanced mixing, the tests done with cratered holes show lateral spreading of the jets (fuel) of two to three times that without the craters.

The cratered fuel holes may also be formed as a retrofittable feature that could be applied across combustor designs and can also be used on an as-needed basis when flame forming issues arise in an existing combustor.

By forming crater holes as part of a fuel site, more rapid and complete mixing of fuel with the airflow can be achieved. The construction also reduces jet in cross flow (penetration and wake) effect while still maintaining high levels of mixedness and hence premixer efficiency. By reducing jet in cross flow effects, a rich mixture can be maintained adjacent the premixer (turning vane) surface. Zones of recirculation on the downstream side of the jets are also reduced. The richer mixture adjacent the wall and the reduction of low velocity zones tend to increase flashback/flameholding resistance.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A premixer for a gas turbine combustor, the premixer comprising:
a swirler including a plurality of straight or turning vanes that affect velocity characteristics of airflow through the premixer; and
at least one fuel injection site enabling fuel to mix with the airflow in the premixer, wherein the at least one fuel injection site terminates in a cratered hole.

2. A premixer according to claim 1, wherein at least one fuel injection site is positioned on one of the turning vanes.

3. A premixer according to claim 1, further comprising a plurality of fuel injection sites terminating in respective cratered holes.

4. A premixer according to claim 3, wherein a number of fuel injection sites is determined to obtain an enhanced mixing rate.

5. A premixer according to claim 3, wherein a number of fuel injection sites and a combination of shape and orientation of the cratered holes are determined to obtain an enhanced mixing rate.

6. A premixer according to claim 3, wherein a number of fuel injection sites and a size and depth of the cratered holes are determined to obtain an enhanced mixing rate.

7. A premixer according to claim 1, wherein a fuel injection direction relative to a direction of the airflow is varied to obtain an enhanced mixing rate.

8. A method for improving flashback and flameholding resistance in a gas turbine combustor, the method comprising forming at least one cratered hole at an airflow end of a fuel injection site in a premixer.

9. A method according to claim 8, wherein the at least one cratered hole is formed by one of standard drilling, laser drilling and electronic discharge machining (EDM).

10. A premixer for a gas turbine combustor, the premixer comprising:
a swirler including a plurality of straight or turning vanes that affect velocity characteristics of airflow through the premixer;
a plurality of fuel injection sites enabling fuel to mix with the airflow in the premixer; and
a cratered hole formed at the end of at least one of the fuel injection sites on a surface of at least one of the turning vanes.

11. A premixer according to claim 10, further comprising an additional cratered hole formed at a hub or shroud between the straight or turning vanes.
